(19) United States
(12) Patent Application Publication
(10) Pub. No.: US 2012/0231911 A1
(43) Pub. Date: Sep. 13, 2012

(54) POWER TRAIN HAVING MANIPULATABLE EPICYCLIC TYPE CLUTCH DEVICE

(76) Inventor: Tai-Her YANG, Dzan-Hwa (TW)

(21) Appl. No.: 13/045,636

(22) Filed: Mar. 11, 2011

(51) Int. Cl. F16H 3/72; F16H 48/06

(52) U.S. Cl. 475/4

(57) ABSTRACT

The present invention is through an epicyclic gear set (EG101) and a controllable brake device (BK101) to structure the clutch function for replacing the conventional friction type electromagnetic clutch device, and combined with a single rotary kinetic power source to constitute a power train having controllable epicyclic type clutch device.

### BACKGROUND OF THE INVENTION

(a) Field of the Invention

The present invention is through an epicyclic gear set (EG101) and a controllable brake device (BK101) to structure the clutch function for replacing the conventional friction type electromagnetic clutch device, and combined with a single rotary kinetic power source to constitute a power train having controllable epicyclic type clutch device.

(b) Description of the Prior Art

For a conventional automatic or semi-automatic power train or hybrid power train, between the rotary kinetic power source and the transmission device, a friction type electromagnetic clutch device is often controlled for performing engagement or disengagement, for allowing the system to operate various functions; however, when the friction type electromagnetic clutch device is in a disengaged state, residual torque may remain, and the disadvantages of power loss or system malfunction may occur.

### SUMMARY OF THE INVENTION

The present invention provides a power train having controllable epicyclic type clutch device, in which a controllable brake device (BK101) is used to control an epicyclic gear set (EG101) to constitute the function of controllable epicyclic type clutch device; the power train adopting the clutch device structured by the controllable brake device (BK101) controlling the epicyclic gear set (EG101) can be widely applied in a power train driven by single rotary kinetic power source, and the structural type can be an in-series coaxial line structure, or multiple in-parallel axial lines for satisfying the requirements of the applied space.

### BRIEF DESCRIPTION OF THE DRAWINGS

FIG. 1 is a schematic structural view showing the output end of a first rotary kinetic power source (P1) being combined with a rotation shaft (S101) combined with an input wheel (W101) of an epicyclic gear set (EG101), and a rocker arm (A101) or a sleeve type rotation shaft (AS101) driven by an epicyclic wheel (W103) of the epicyclic gear set (EG101) being connected to an action side of a controllable brake device (BK101) while the other action side of the controllable brake device (BK101) being fixed in a housing (H100).

FIG. 2 is a schematic view showing the structure shown in FIG. 1 wherein a first transmission device (T1) being installed between the first rotary kinetic power source (P1) and the rotation shaft (S101) driven by the input wheel (W101) of the epicyclic gear set (EG101), according to one embodiment of the present invention.

FIG. 3 is a schematic view showing the structure shown in FIG. 1 wherein the output wheel (W102) of the epicyclic gear set (EG101) and the output/input end of the rotation shaft (S102) being installed with a second transmission device (T2) and an output/input end rotation shaft (S1021), according to one embodiment of the present invention.

FIG. 4 is a schematic view showing the structure shown in FIG. 1 wherein the first transmission device (T1) being installed between the first rotary kinetic power source (P1) and the rotations shaft (S101) driven by the input wheel (W101) of the epicyclic gear set (EG101), and the output wheel (W102) of the epicyclic gear set (EG101) and the output/input end of the rotation shaft (S102) being installed with the second transmission device (T2) and the output/input end rotation shaft (S1021), according to one embodiment of the present invention.

FIG. 5 is a schematic structural view showing the rotation shaft (S102) combined with the first rotary kinetic power source (P1) and the transmission unit (T200) and the epicyclic gear set (EG101) and the output wheel (W102) of the epicyclic gear set (EG101) being combined at an action side of a controllable brake device (BK102), and the other action side of the controllable brake device (BK102) is fixed in the housing (H100), and the rocker arm (A101) or the sleeve type rotation shaft (AS101) driven by the epicyclic wheel (W103) of the epicyclic gear set (EG101) being combined with the an input end rotation shaft (S1031) of the transmission unit (T200), and the output end of the transmission unit (T200) being installed with a rotation shaft (S110), according to one embodiment of the present invention.

FIG. 6 is a schematic view showing the structure shown in FIG. 5 wherein the first transmission device (T1) being installed between the rotation shaft (S101) combined with the input wheel (W101) of the epicyclic gear set (EG101) and the first rotary kinetic power source (P1), according to one embodiment of the present invention.

FIG. 7 is a schematic view showing the structure shown in FIG. 5 wherein a planetary gear set (T300) being installed between the input end rotation shaft (S1031) of the transmission unit (T200) and the rocker arm (A101) or the sleeve type rotation shaft (AS101) driven by the epicyclic wheel (W103) of the epicyclic gear set (EG101), according to one embodiment of the present invention.

FIG. 8 is a schematic view showing the structure shown in FIG. 5 wherein the first transmission device (T1) being installed between the rotation shaft (S101) combined with the input wheel (W101) of the epicyclic gear set (EG101) and the first rotary kinetic power source (P1), and the planetary gear set (T300) being installed between the input end rotation shaft (S1031) of the transmission unit (T200) and the rocker arm (A101) or the sleeve type rotation shaft (AS101) driven by the epicyclic wheel (W103) of the epicyclic gear set (EG101), according to one embodiment of the present invention.

FIG. 9 is a schematic view showing the structure shown in FIG. 5 wherein the transmission unit (T200) being replaced by a differential output epicyclic gear set (T400), according to one embodiment of the present invention.

FIG. 10 is a schematic structural view showing the transmission unit (T200) shown in FIG. 6 being replaced by the differential output epicyclic gear set (T400), according to one embodiment of the present invention.

FIG. 11 is a schematic structural view showing the transmission unit (T200) shown in FIG. 7 being replaced by the differential output epicyclic gear set (T400), according to one embodiment of the present invention.

FIG. 12 is a schematic structural view showing the transmission unit (T200) shown in FIG. 8 being replaced by the differential output epicyclic gear set (T400), according to one embodiment of the present invention.

FIG. 13 is a schematic structural view showing a limited slip differential device (LSD401) being installed between the output/input wheel (W401) and the output/input wheel (W402) of the differential output epicyclic gear set (T400), according to one embodiment of the present invention.

### DESCRIPTION OF MAIN COMPONENT SYMBOLS

A101 [symbol] A111 [symbol] A401: Rocker arm

AS101 [symbol] AS111 [symbol] AS401: Sleeve type rotation shaft

BK101 [symbol] BK102: Controllable brake device

EG101: Epicyclic gear set

H100: Housing

LSD401: Limited slip differential device

P1: First rotary kinetic power source

S101 [symbol] S102 [symbol] S110 [symbol] S1011 [symbol] S1012 [symbol] S1013 [symbol] S1021 [symbol] S1022 [symbol] S1023 [symbol] S1031 [symbol] S1032 [symbol] S1041: Rotation shaft

S401 [symbol] S402: Differential output/input end rotation shaft

T1: Transmission device

T2: Transmission device

T200: Transmission unit

T300: Planetary gear set

T400: Differential output epicyclic gear set

W101: Input wheel

W102: Output wheel

W103 [symbol] W403: Epicyclic wheel

W300: Transmission wheel

W400: Annular input wheel

W401 [symbol] W402: Output/input wheel

W111: Sun wheel

W112: Planetary wheel

W113: Outer annular wheel

### DETAILED DESCRIPTION OF THE PREFERRED EMBODIMENTS

For a conventional automatic or semi-automatic power train or hybrid power train, between the rotary kinetic power source and the transmission device, a friction type electromagnetic clutch device is often controlled for performing engagement or disengagement, for allowing the system to operate various functions; however, when the friction type electromagnetic clutch device is in a disengaged state, residual torque may remain, and the disadvantages of power loss or system malfunction may occur.

The present invention is through an epicyclic gear set (EG101) and a controllable brake device (BK101) to structure the clutch function for replacing the conventional friction type electromagnetic clutch device, and combined with a single rotary kinetic power source to constitute a power train having controllable epicyclic type clutch device.

The present invention provides a power train having controllable epicyclic type clutch device, in which a controllable brake device (BK101) is used to control an epicyclic gear set (EG101) to constitute the function of controllable epicyclic type clutch device; the power train adopting the clutch device structured by the controllable brake device (BK101) controlling the epicyclic gear set (EG101) can be widely applied in a power train driven by single rotary kinetic power source, and the structural type can be an in-series coaxial line structure, or multiple in-parallel axial lines for satisfying the requirements of the applied space.

The structures and embodiments of the power train having controllable epicyclic type clutch device are as followings:

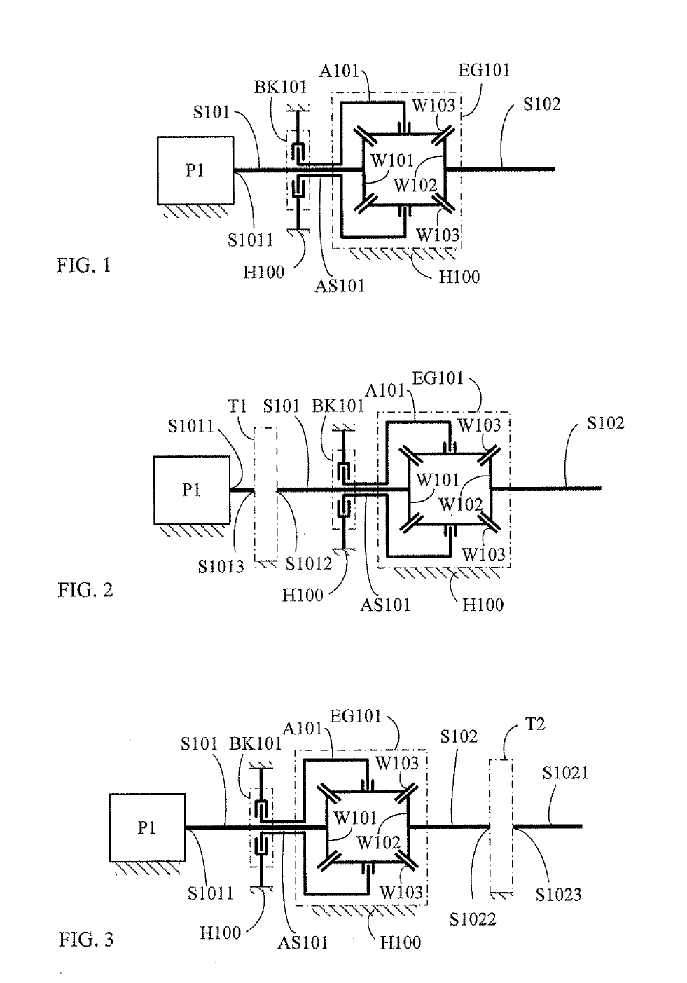

FIG. 1 is a schematic structural view showing the output end of a first rotary kinetic power source (P1) being combined with a rotation shaft (S101) combined with an input wheel (W101) of an epicyclic gear set (EG101), and a rocker arm (A101) or a sleeve type rotation shaft (AS101) driven by an epicyclic wheel (W103) of the epicyclic gear set (EG101) being connected to an action side of a controllable brake device (BK101) while the other action side of the controllable brake device (BK101) being fixed in a housing (H100).

As shown in FIG. 1, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK101): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the sleeve type rotation shaft (AS101) or the rocker arm (A101), and the other action side is fixed in the housing (H100);
One end of the rotation shaft (S101) is combined with the input wheel (W101) of the epicyclic gear set (EG101), and the other end of the rotation shaft (S101) is combined with an output/input end rotation shaft (S1011) of the first rotary kinetic power source (P1), and the rotation shaft (S102) combined with the output wheel (W102) of the epicyclic gear set (EG101) is served as an output/input end, the shell of the epicyclic gear set (EG101) is fixed in the housing (H100), the epicyclic wheel (W103) of the epicyclic gear set (EG101) is provided for combining the rocker arm (A101) and combining the sleeve type rotation shaft (AS101), the sleeve type rotation shaft (AS101) rotates on the rotation shaft (S101), the sleeve type rotation shaft (AS101) or the rocker arm (A101) is combined to an action side of the controllable brake device (BK101), and the other action side of the controllable brake device (BK101) is fixed in the housing (H100); through controlling the controllable brake device (BK101) to perform brake locking or releasing, the function of connecting for transmission or releasing between the rotation shaft (S101) and the rotation shaft (S102) is enabled to be controlled.

FIG. 2 is a schematic view showing the structure shown in FIG. 1 wherein a first transmission device (T1) being installed between the first rotary kinetic power source (P1) and the rotation shaft (S101) driven by the input wheel (W101) of the epicyclic gear set (EG101), according to one embodiment of the present invention.

As shown in FIG. 2, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK101): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the sleeve type rotation shaft (AS101) or the rocker arm (A101), and the other action side is fixed in the housing (H100);
First transmission device (T1): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
The other end of the rotation shaft (S101) combined with the input wheel (W101) of the epicyclic gear set (EG101) is combined with the output/input end rotation shaft (S1012) of the first transmission device (T1), the output/input end rotation shaft (S1013) at the other end of the first transmission device (T1) is combined with an output/input end rotation shaft (S1011) of the first rotary kinetic power source (P1), and the rotation shaft (S102) combined with the output wheel (W102) of the epicyclic gear set (EG101) is served as an output/input end, the shell of the epicyclic gear set (EG101) is fixed in the housing (H100), the epicyclic wheel (W103) of the epicyclic gear set (EG101) is provided for combining the rocker arm (A101) and combining the sleeve type rotation shaft (AS101), the sleeve type rotation shaft (AS101) rotates on the rotation shaft (S101), the sleeve type rotation shaft (AS101) or the rocker arm (A101) is combined to an action side of the controllable brake device (BK101), and the other action side of the controllable brake device (BK101) is fixed in the housing (H100); through controlling the controllable brake device (BK101) to perform brake locking or releasing, the function of connecting for transmission or releasing between the rotation shaft (S101) and the rotation shaft (S102) is enabled to be controlled.

FIG. 3 is a schematic view showing the structure shown in FIG. 1 wherein the output wheel (W102) of the epicyclic gear set (EG101) and the output/input end of the rotation shaft (S102) being installed with a second transmission device (T2) and an output/input end rotation shaft (S1021), according to one embodiment of the present invention.

As shown in FIG. 3, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK101): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the sleeve type rotation shaft (AS101) or the rocker arm (A101), and the other action side is fixed in the housing (H100);
Second transmission device (T2): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
The rotation shaft (S101) combined with the input wheel (W101) of the epicyclic gear set (EG101) is combined with the output/input end rotation shaft (S1011) of the first rotary kinetic power source (P1), and the rotation shaft (S102) combined with the output wheel (W102) of the epicyclic gear set (EG101) is combined with the output/input end rotation shaft (S1022) of the second transmission device (T2), the output/input end rotation shaft (S1023) at the other end of the second transmission device (T2) is combined with the rotation shaft (S1021) for serving as an output/input end, the shell of the epicyclic gear set (EG101) is fixed in the housing (H100), the epicyclic wheel (W103) of the epicyclic gear set (EG101) is provided for combining the rocker arm (A101) and combining the sleeve type rotation shaft (AS101), the sleeve type rotation shaft (AS101) rotates on the rotation shaft (S101), the sleeve type rotation shaft (AS101) or the rocker arm (A101) is combined to an action side of the controllable brake device (BK101), and the other action side of the controllable brake device (BK101) is fixed in the housing (H100); through controlling the controllable brake device (BK101) to perform brake locking or releasing, the function of connecting for transmission or releasing between the rotation shaft (S101) and the rotation shaft (S102) is enabled to be controlled.

FIG. 4 is a schematic view showing the structure shown in FIG. 1 wherein the first transmission device (T1) being installed between the first rotary kinetic power source (P1) and the rotations shaft (S101) driven by the input wheel (W101) of the epicyclic gear set (EG101), and the output wheel (W102) of the epicyclic gear set (EG101) and the output/input end of the rotation shaft (S102) being installed with the second transmission device (T2) and the output/input end rotation shaft (S1021), according to one embodiment of the present invention.

As shown in FIG. 4, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK101): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the sleeve type rotation shaft (AS101) or the rocker arm (A101), and the other action side is fixed in the housing (H100);
First transmission device (T1), Second transmission device (T2): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
The other end of the rotation shaft (S101) combined with the input wheel (W101) of the epicyclic gear set (EG101) is combined with the output/input end rotation shaft (S1012) of the first transmission device (T1), and the output/input end rotation shaft (S1013) at the other end of the first transmission device (T1) is combined with the output/input end rotation shaft (S1011) of the first rotary kinetic power source (P1), the rotation shaft (S102) combined with the output wheel (W102) of the epicyclic gear set (EG101) is combined with the output/input end rotation shaft (S1022) of the second transmission device (T2), the output/input end rotation shaft (S1023) at the other end of the second transmission device (T2) is combined with the rotation shaft (S1021) for serving as an output/input end, the shell of the epicyclic gear set (EG101) is fixed in the housing (H100), the epicyclic wheel (W103) of the epicyclic gear set (EG101) is provided for combining the rocker arm (A101) and combining the sleeve type rotation shaft (AS101), the sleeve type rotation shaft (AS101) rotates on the rotation shaft (S101), the sleeve type rotation shaft (AS101) or the rocker arm (A101) is combined to an action side of the controllable brake device (BK101), and the other action side of the controllable brake device (BK101) is fixed in the housing (H100); through controlling the controllable brake device (BK101) to perform brake locking or releasing, the function of connecting for transmission or releasing between the rotation shaft (S101) and the rotation shaft (S102) is enabled to be controlled.

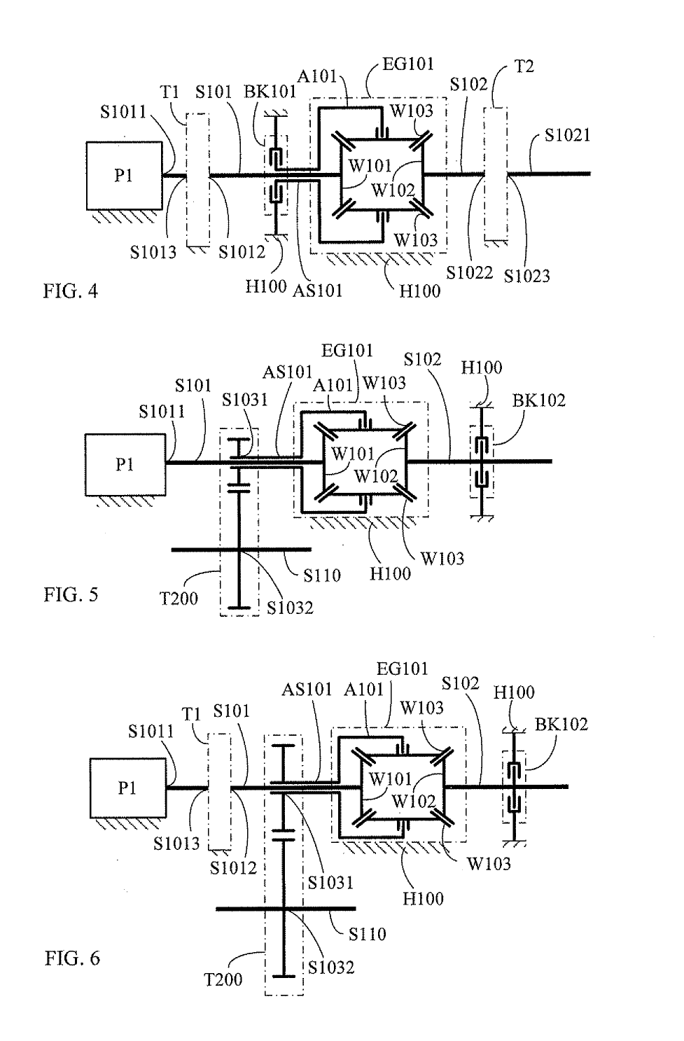

FIG. 5 is a schematic structural view showing the rotation shaft (S102) combined with the first rotary kinetic power source (P1) and the transmission unit (T200) and the epicyclic gear set (EG101) and the output wheel (W102) of the epicyclic gear set (EG101) being combined at an action side of a controllable brake device (BK102), and the other action side of the controllable brake device (BK102) is fixed in the housing (H100), and the rocker arm (A101) or the sleeve type rotation shaft (AS101) driven by the epicyclic wheel (W103) of the epicyclic gear set (EG101) being combined with the an input end rotation shaft (S1031) of the transmission unit (T200), and the output end of the transmission unit (T200) being installed with a rotation shaft (S110), according to one embodiment of the present invention.

As shown in FIG. 5, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Transmission unit (T200): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
One end of the rotation shaft (S101) is combined with an output/input end rotation shaft (S1011) of the first rotary kinetic power source (P1), and the other end of the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to one action side of the controllable brake device (BK102), the other action side of the controllable brake device (BK102) is fixed in the housing (H100), the epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101), the sleeve type rotation shaft (AS101) drives the output/input end rotation shaft (S1031) of the transmission unit (T200), and the other output/input end rotation shaft (S1032) of the transmission unit (T200) drives the output/input end rotation shaft (S110).

FIG. 6 is a schematic view showing the structure shown in FIG. 5 wherein the first transmission device (T1) being installed between the rotation shaft (S101) combined with the input wheel (W101) of the epicyclic gear set (EG101) and the first rotary kinetic power source (P1), according to one embodiment of the present invention.

As shown in FIG. 6, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
First transmission device (T1): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
Transmission unit (T200): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
The output/input end rotation shaft (S1011) of the first rotary kinetic power source (P1) is combined with the output/input end rotation shaft (S1013) of the first transmission device (T1), the output/input end rotation shaft (S1012) of the first transmission device (T1) is combined with the rotation shaft (S101), the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to one action side of the controllable brake device (BK102), the other action side of the controllable brake device (BK102) is fixed in the housing (H100), the epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101), and the sleeve type rotation shaft (AS101) drives the output/input end rotation shaft (S1031) of the transmission unit (T200), and the other output/input end rotation shaft (S1032) of the transmission unit (T200) drives the output/input end rotation shaft (S110).

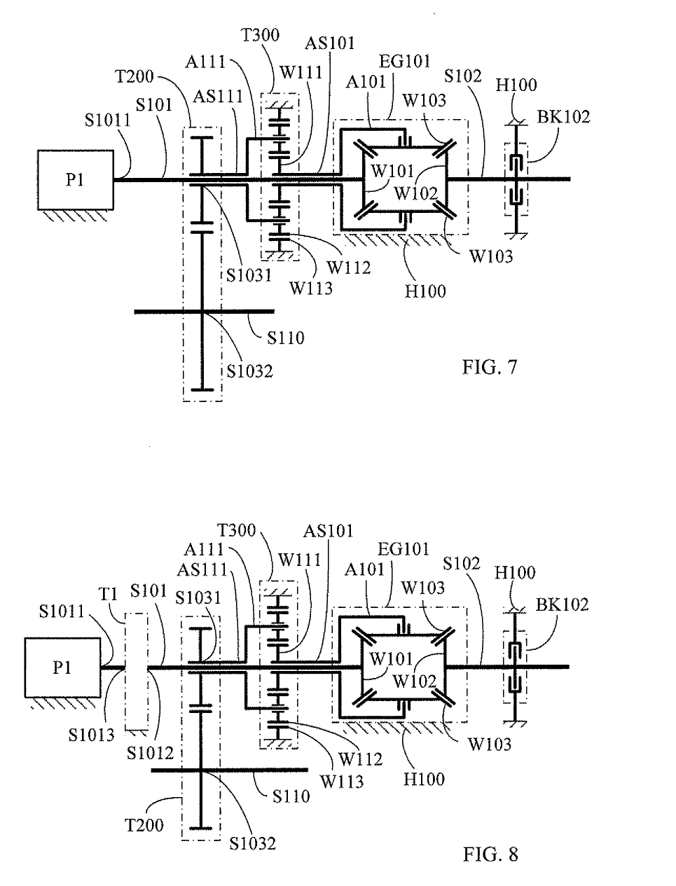

FIG. 7 is a schematic view showing the structure shown in FIG. 5 wherein a planetary gear set (T300) being installed between the input end rotation shaft (S1031) of the transmission unit (T200) and the rocker arm (A101) or the sleeve type rotation shaft (AS101) driven by the epicyclic wheel (W103) of the epicyclic gear set (EG101), according to one embodiment of the present invention.

As shown in FIG. 7, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
Transmission unit (T200): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Planetary gear set (T300): which is constituted by friction wheels or gears, including a sun wheel (W111), a planetary wheel (W112), an outer annular wheel (W113) and a shell to be fixed in the housing (H100), wherein the outer annular wheel (W113) is fixed on the shell then fixed on the housing (H100) or directly fixed on the shell, the planetary wheel (W112) is combined with the rocker arm (A111) and combined with the sleeve type rotation shaft (AS111), the sleeve type rotation shaft (AS111) rotates on the rotation shaft (S101) and drives the output/input end rotation shaft (S1031) of the transmission unit (T200), and the sun wheel (W111) is combined with the sleeve type rotation shaft (AS101) of the epicyclic gear set (EG101);
One end of the rotation shaft (S101) is combined with the output/input end rotation shaft (S1011) of the first rotary kinetic power source (P1), the other end of the rotation shaft (S101) is combined with the input wheel (W101) of the epicyclic gear set (EG101), the shell of the epicyclic gear set (EG101) is fixed in the housing (H100), the output/input end rotation shaft (S102) combined with the output wheel (W102) of the epicyclic gear set (EG101) is combined to an action side of the controllable brake device (BK102), and the other action side of the controllable brake device (BK102) is fixed in the housing (H100);
The epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101) and drives the sun wheel (W111) of the planetary gear set (T300), the outer annular wheel (W113) of the planetary gear set (T300) is fixed on the housing (H100) through the shell of the planetary gear set (T300) or the outer annular wheel (W113) is directly fixed in the housing (H100), the planetary wheel (W112) of the planetary gear set (T300) is combined with the rocker arm (A111) and combined with the sleeve type rotation shaft (AS111) for driving the output/input end rotation shaft (S1031) of the transmission unit (T200), and the other output/input end rotation shaft (S1032) of the transmission unit (T200) drives the rotation shaft (S110).

FIG. 8 is a schematic view showing the structure shown in FIG. 5 wherein the first transmission device (T1) being installed between the rotation shaft (S101) combined with the input wheel (W101) of the epicyclic gear set (EG101) and the first rotary kinetic power source (P1), and the planetary gear set (T300) being installed between the input end rotation shaft (S1031) of the transmission unit (T200) and the rocker arm (A101) or the sleeve type rotation shaft (AS101) driven by the epicyclic wheel (W103) of the epicyclic gear set (EG101), according to one embodiment of the present invention.

As shown in FIG. 8, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
First transmission device (T1): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Transmission unit (T200): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Planetary gear set (T300): which is constituted by friction wheels or gears, including a sun wheel (W111), a planetary wheel (W112), an outer annular wheel (W113) and a shell to be fixed in the housing (H100), wherein the outer annular wheel (W113) is fixed on the shell then fixed on the housing (H100) or directly fixed on the shell, the planetary wheel (W112) is combined with the rocker arm (A111) and combined with the sleeve type rotation shaft (AS111), the sleeve type rotation shaft (AS111) rotates on the rotation shaft (S101) and drives the output/input end rotation shaft (S1031) of the transmission unit (T200), and the sun wheel (W111) is combined with the sleeve type rotation shaft (AS101) of the epicyclic gear set (EG101);
The output/input end rotation shaft (S1011) of the first rotary kinetic power source (P1) is combined with the output/input end rotation shaft (S1013) of the first transmission device (T1), the output/input end rotation shaft (S1012) of the first transmission device (T1) is combined with the rotation shaft (S101), the rotation shaft (S101) is combined with the input wheel (W101) of the epicyclic gear set (EG101), the shell of the epicyclic gear set (EG101) is fixed in the housing (H100), the output/input end rotation shaft (S102) combined with the output wheel (W102) of the epicyclic gear set (EG101) is combined to an action side of the controllable brake device (BK102), and the other action side of the controllable brake device (BK102) is fixed in the housing (H100);
The epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101) and drives the sun wheel (W111) of the planetary gear set (T300), the outer annular wheel (W113) of the planetary gear set (T300) is fixed on the housing (H100) through the shell of the planetary gear set (T300) or the outer annular wheel (W113) is directly fixed in the housing (H100), the planetary wheel (W112) of the planetary gear set (T300) is combined with the rocker arm (A111) and combined with the sleeve type rotation shaft (AS111) for driving the output/input end rotation shaft (S1031) of the transmission unit (T200), and the other output/input end rotation shaft (S1032) of the transmission unit (T200) drives the rotation shaft (S110).

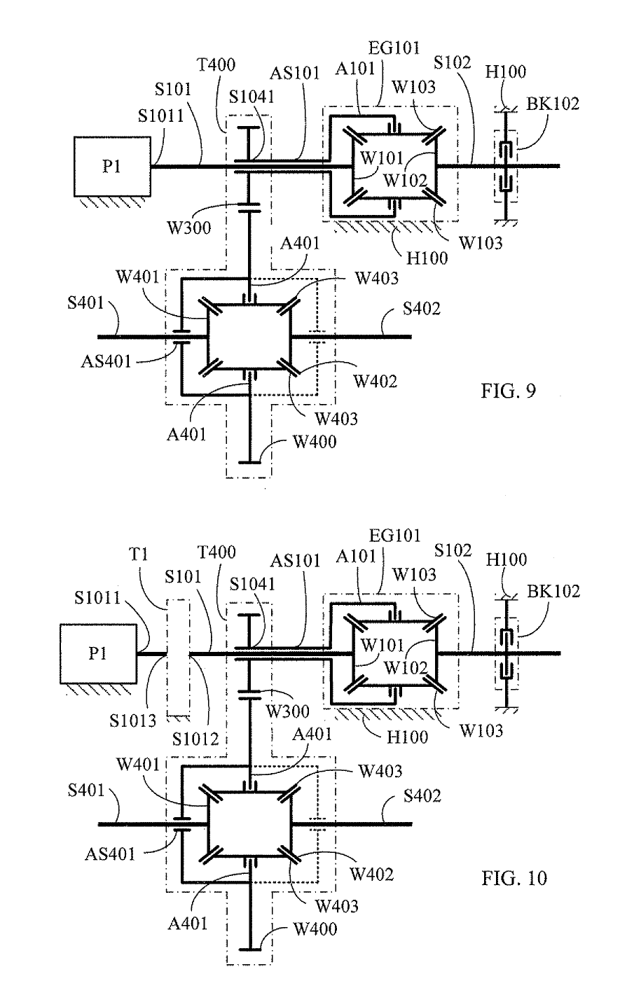

FIG. 9 is a schematic view showing the structure shown in FIG. 5 wherein the transmission unit (T200) being replaced by a differential output epicyclic gear set (T400), according to one embodiment of the present invention.

As shown in FIG. 9, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable, action sides for the operations of a brake locking state for engagement or a releasing state for separation, wherein one of the action sides is connected to the rotation shaft (S102), and the other action side is fixed in the housing (H100);
Differential output epicyclic gear set (T400): an epicyclic gear set structured including by an output/input wheel (W401), an output/input wheel (W402) and an epicyclic wheel (W403), wherein the output/input wheel (W401) is combined with a differential output/input end rotation shaft (S401), the output/input wheel (W402) is combined with a differential output/input end rotation shaft (S402), the epicyclic wheel (W403) rotates on a rocker arm (A401), the rocker arm (A401) is combined with an annular input wheel (W400) for being combined with a sleeve type rotation shaft (AS401), and the sleeve type rotation shaft (AS401) rotates on one or both of the differential output/input end rotation shaft (S401) or the differential output/input end rotation shaft (S402), the annular input wheel (W400) is driven by a transmission wheel (W300), and the transmission wheel (W300) is driven by the external rotary kinetic power, i.e. driven by the sleeve type rotation shaft (AS101);

The mentioned output/input wheel (W401), the output/input wheel (W402) and the epicyclic wheel (W403) are composed of bevel gears or bevel friction wheels;

The transmission function structured by the transmission wheel (W300) and the annular input wheel (W400) includes being constituted by the automatic, manumatic, semi-automatic, or manual gear shifting device with fixed or variable speed ratios which is structured by the transmission gear set composed of gears, friction wheels, pulleys and pulley belts, chains and chain wheels, or the planetary type transmission gear set, or the epicyclic type transmission gear set, or CVT, or the hydraulic transmission device, and a shell and the bearings;
One end of the rotation shaft (S101) is combined with the output/input end rotation shaft (S1011) of the first rotary kinetic power source (P1), the other end of the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to an action side of the controllable brake device (BK102), the other action side of the controllable brake device (BK102) is fixed in the housing (H100), the epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101), and the sleeve type rotation shaft (AS101) is used to drive the output/input end rotation shaft (S1041) of the differential output epicyclic gear set (T400), and the transmission wheel (W300) drives the annular input wheel (W400) and then through the epicyclic wheel (W403) drives the output/input wheel (W401) and the output/input wheel (W402), the differential output/input end rotation shaft (S401) is connected to the output/input wheel (W401) for being driven by the output/input wheel (W401), the differential output/input end rotation shaft (S402) is connected to the output/input wheel (W402) for being driven by the output/input wheel (W402), and the differential operation is enabled to be performed between the differential output/input end rotation shaft (S401) and the differential output/input end rotation shaft (S402) through the epicyclic wheel (W403).

FIG. 10 is a schematic structural view showing the transmission unit (T200) shown in FIG. 6 being replaced by the differential output epicyclic gear set (T400), according to one embodiment of the present invention.

As shown in FIG. 10, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel

(W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
First transmission device (T1): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Differential output epicyclic gear set (T400): an epicyclic gear set structured including by having an output/input wheel (W401), an output/input wheel (W402) and an epicyclic wheel (W403), wherein the output/input wheel (W401) is combined with a differential output/input end rotation shaft (S401), the output/input wheel (W402) is combined with a differential output/input end rotation shaft (S402), the epicyclic wheel (W403) rotates on a rocker arm (A401), the rocker arm (A401) is combined with an annular input wheel (W400) for being combined with a sleeve type rotation shaft (AS401), and the sleeve type rotation shaft (AS401) rotates on one or both of the differential output/input end rotation shaft (S401) or the differential output/input end rotation shaft (S402), the annular input wheel (W400) is driven by a transmission wheel (W300), and the transmission wheel (W300) is driven by the external rotary kinetic power, i.e. driven by the sleeve type rotation shaft (AS101);

The mentioned output/input wheel (W401), the output/input wheel (W402) and the epicyclic wheel (W403) are composed of bevel gears or bevel friction wheels;

The transmission function structured by the transmission wheel (W300) and the annular input wheel (W400) includes being constituted by the automatic, manumatic, semi-automatic, or manual gear shifting device with fixed or variable speed ratios which is structured by the transmission gear set composed of gears, friction wheels, pulleys and pulley belts, chains and chain wheels, or the planetary type transmission gear set, or the epicyclic type transmission gear set, or CVT, or the hydraulic transmission device, and a shell and the bearings;
The output/input end rotation shaft (S1011) of the first rotary kinetic power source (P1) is combined with the output/input end rotation shaft (S1013) of the first transmission device (T1), the output/input end rotation shaft (S1012) of the first transmission device (T1) is combined with the rotation shaft (S101), the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to an action side of the controllable brake device (BK102), the other action side of the controllable brake device (BK102) is fixed in the housing (H100), the epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101), and the sleeve type rotation shaft (AS101) is used to drive the output/input end rotation shaft (S1041) of the differential output epicyclic gear set (T400), and the transmission wheel (W300) drives the annular input wheel (W400) and then through the epicyclic wheel (W403) drives the output/input wheel (W401) and the output/input wheel (W402), the differential output/input end rotation shaft (S401) is connected to the output/input wheel (W401) for being driven by the output/input wheel (W401), the differential output/input end rotation shaft (S402) is connected to the output/input wheel (W402) for being driven by the output/input wheel (W402), and the differential operation is enabled to be performed between the differential output/input end rotation shaft (S401) and the differential output/input end rotation shaft (S402) through the epicyclic wheel (W403).

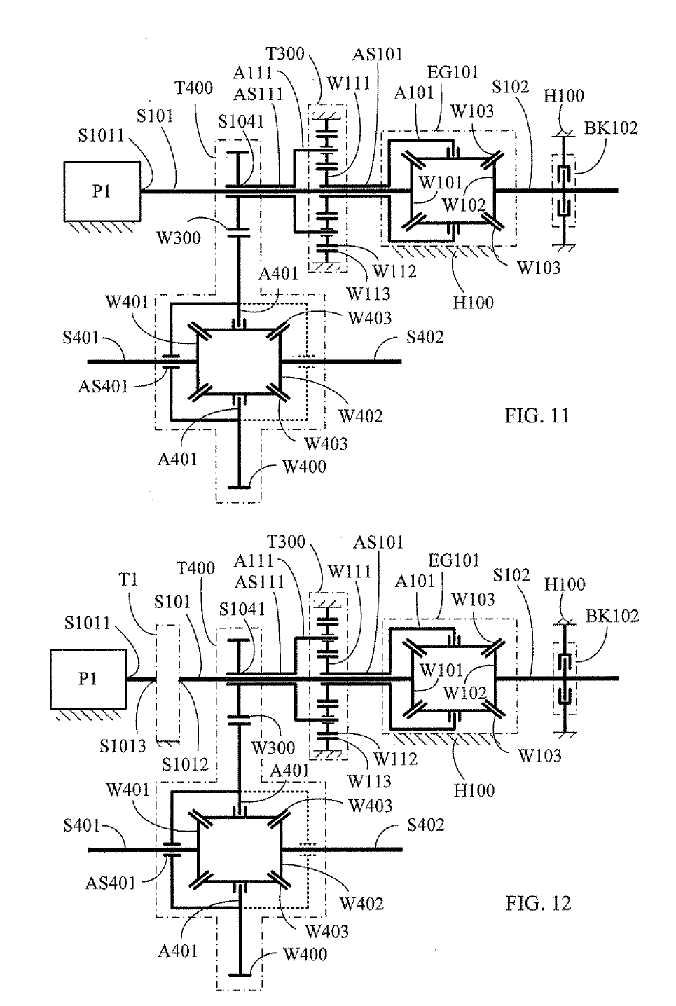

FIG. 11 is a schematic structural view showing the transmission unit (T200) shown in FIG. 7 being replaced by the differential output epicyclic gear set (T400), according to one embodiment of the present invention.

As shown in FIG. 11, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel

(W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected the rotation shaft (S102), and the other action side is fixed in the housing (H100);
Differential output epicyclic gear set (T400): an epicyclic gear set structured including by having an output/input wheel (W401), an output/input wheel (W402) and an epicyclic wheel (W403), wherein the output/input wheel (W401) is combined with a differential output/input end rotation shaft (S401), the output/input wheel (W402) is combined with a differential output/input end rotation shaft (S402), the epicyclic wheel (W403) rotates on a rocker arm (A401), the rocker arm (A401) is combined with an annular input wheel (W400) for being combined with a sleeve type rotation shaft (AS401), and the sleeve type rotation shaft (AS401) rotates on one or both of the differential output/input end rotation shaft (S401) or the differential output/input end rotation shaft (S402), the annular input wheel (W400) is driven by a transmission wheel (W300), and the transmission wheel (W300) is driven by the external rotary kinetic power, i.e. driven by the sleeve type rotation shaft (AS111);

The mentioned output/input wheel (W401), the output/input wheel (W402) and the epicyclic wheel (W403) are composed of bevel gears or bevel friction wheels;

The transmission function structured by the transmission wheel (W300) and the annular input wheel (W400) includes being constituted by the automatic, manumatic, semi-automatic, or manual gear shifting device with fixed or variable speed ratios which is structured by the transmission gear set composed of gears, friction wheels, pulleys and pulley belts, chains and chain wheels, or the planetary type transmission gear set, or the epicyclic type transmission gear set, or CVT, or the hydraulic transmission device, and a shell and the bearings;
Planetary gear set (T300): which is constituted by friction wheels or gears, including a sun wheel (W111), a planetary wheel (W112), an outer annular wheel (W113) and a shell to be fixed in the housing (H100), wherein the outer annular wheel (W113) is fixed on the shell then fixed on the housing (H100) or directly fixed on the shell, the planetary wheel (W112) is combined with the rocker arm (A111) and combined with the sleeve type rotation shaft (AS111), the sleeve type rotation shaft (AS111) rotates on the rotation shaft (S101) and drives the output/input end rotation shaft (S1041) of the differential output epicyclic gear set (T400), and the sun wheel (W111) is combined with the sleeve type rotation shaft (AS101) of the epicyclic gear set (EG101);
One end of the rotation shaft (S101) is combined with the rotation shaft (S101) of the first rotary kinetic power source (P1), the other end of the rotation shaft (S101) is combined with the input wheel (W101) of the epicyclic gear set (EG101), the shell of the epicyclic gear set (EG101) is fixed in the housing (H100), the output/input end rotation shaft (S102) combined with the output wheel (W102) of the epicyclic gear set (EG101) is combined to an action side of the controllable brake device (BK102), and the other action side of the controllable brake device (BK102) is fixed in the housing (H100);
The epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101) and drives the sun wheel (W111) of the planetary gear set (T300), the outer annular wheel (W113) of the planetary gear set (T300) is fixed in the housing (H100) through the shell of the planetary gear set (T300) or the outer annular wheel (W113) is directly fixed in the housing (H100), the planetary wheel (W112) of the planetary gear set (T300) is combined with the rocker arm (A111) and combined with the sleeve type rotation shaft (AS111) for driving the output/input end rotation shaft (S1041) of the differential output epicyclic gear set (T400), and the transmission wheel (W300) drives the annular input wheel (W400) and then through the epicyclic wheel (W403) drives the output/input wheel (W401) and the output/input wheel (W402), the differential output/input end rotation shaft (S401) is connected to the output/input wheel (W401) for being driven by the output/input wheel (W401), the differential output/input end rotation shaft (S402) is connected to the output/input wheel (W402) for being driven by the output/input wheel (W402), and the differential operation is enabled to be performed between the differential output/input end rotation shaft (S401) and the differential output/input end rotation shaft (S402) through the epicyclic wheel (W403).

FIG. 12 is a schematic structural view showing the transmission unit (T200) shown in FIG. 8 being replaced by the differential output epicyclic gear set (T400), according to one embodiment of the present invention.

As shown in FIG. 12, it mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
First transmission device (T1): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Planetary gear set (T300): which is constituted by friction wheels or gears, including a sun wheel (W111), a planetary wheel (W112), an outer annular wheel (W113) and a shell to be fixed in the housing (H100), wherein the outer annular wheel (W113) is fixed on the shell then fixed on the housing (H100) or directly fixed on the shell, the planetary wheel (W112) is combined with the rocker arm (A111) and combined with the sleeve type rotation shaft (AS111), the sleeve type rotation shaft (AS111) rotates on the rotation shaft (S101) and drives the output/input end rotation shaft (S1041) of the differential output epicyclic gear set (T400), and the sun wheel (W111) is combined with the sleeve type rotation shaft (AS101) of the epicyclic gear set (EG101);
Differential output epicyclic gear set (T400): an epicyclic gear set structured including by having an output/input wheel (W401), an output/input wheel (W402) and an epicyclic wheel (W403), wherein the output/input wheel (W401) is combined with a differential output/input end rotation shaft (S401), the output/input wheel (W402) is combined with a differential output/input end rotation shaft (S402), the epicyclic wheel (W403) rotates on a rocker arm (A401), the rocker arm (A401) is combined with an annular input wheel (W400) for being combined with a sleeve type rotation shaft (AS401), and the sleeve type rotation shaft (AS401) rotates on one or both of the differential output/input end rotation shaft (S401) or the differential output/input end rotation shaft (S402), the annular input wheel (W400) is driven by a transmission wheel (W300), and the transmission wheel (W300) is driven by the external rotary kinetic power, i.e. driven by the sleeve type rotation shaft (AS111);

The mentioned output/input wheel (W401), the output/input wheel (W402) and the epicyclic wheel (W403) are composed of bevel gears or bevel friction wheels;

The transmission function structured by the transmission wheel (W300) and the annular input wheel (W400) includes being constituted by the automatic, manumatic, semi-automatic, or manual gear shifting device with fixed or variable speed ratios which is structured by the transmission gear set composed of gears, friction wheels, pulleys and pulley belts, chains and chain wheels, or the planetary type transmission gear set, or the epicyclic type transmission gear set, or CVT, or the hydraulic transmission device, and a shell and the bearings;
The output/input end rotation shaft (S1011) of the first rotary kinetic power source (P1) is combined with the output/input end rotation shaft (S1013) of the first transmission device (T1), the output/input end rotation shaft (S1012) of the first transmission device (T1) is combined with the rotation shaft (S101), the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to an action side of the controllable brake device (BK102), the other action side of the controllable brake device (BK102) is fixed in the housing (H100);
The epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101) and drives the sun wheel (W111) of the planetary gear set (T300), the outer annular wheel (W113) of the planetary gear set (T300) is fixed in the housing (H100) through the shell of the planetary gear set (T300) or the outer annular wheel (W113) is directly fixed in the housing (H100), the planetary wheel (W112) of the planetary gear set (T300) is combined with the rocker arm (A111) and combined with the sleeve type rotation shaft (AS111) for driving the output/input end rotation shaft (S1041) of the differential output epicyclic gear set (T400), and the transmission wheel (W300) drives the annular input wheel (W400) and then through the epicyclic wheel (W403) drives the output/input wheel (W401) and the output/input wheel (W402), the differential output/input end rotation shaft (S401) is connected to the output/input wheel (W401) for being driven by the output/input wheel (W401), the differential output/input end rotation shaft (S402) is connected to the output/input wheel (W402) for being driven by the output/input wheel (W402), and the differential operation is enabled to be performed between the differential output/input end rotation shaft (S401) and the differential output/input end rotation shaft (S402) through the epicyclic wheel (W403).

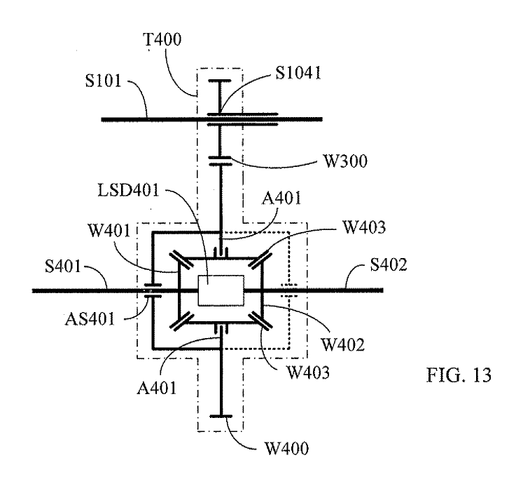

FIG. 13 is a schematic structural view showing a limited slip differential device (LSD401) being installed between the output/input wheel (W401) and the output/input wheel (W402) of the differential output epicyclic gear set (T400), according to one embodiment of the present invention.

As shown in FIG. 13, in the differential output epicyclic gear set (T400) of FIG. 9, FIG. 10, FIG. 11 and FIG. 12, a limited slip differential device (LSD401) can be further installed between shaft ends of the differential output/input end rotation shaft (S401) and the differential output/input end rotation shaft (S402) inside the output/input wheel (W401), the output/input wheel (W402) and the epicyclic wheel (W403), which mainly consists of:
Limited slip differential device (LSD401): which is constituted by a mechanical limited slip differential device, torque sensing type limited slip differential device, viscous coupling type limited slip differential device or electromagnetic coupling type limited slip differential device, and installed in the differential output epicyclic gear set (T400), and disposed between shaft ends of the differential output/input end rotation shaft (S401) and the differential output/input end rotation shaft (S402) inside the output/input wheel (W401), the output/input wheel (W402) and the epicyclic wheel (W403), so when one of the differential output/input end rotation shaft (S401) and the differential output/input end rotation shaft (S402) slips, the other differential output/input end rotation shaft can still output the rotary torque.

1. A power train having controllable epicyclic type clutch device, in which a controllable brake device (BK101) is used to control an epicyclic gear set (EG101) to constitute the function of controllable epicyclic type clutch device; the power train adopting the clutch device structured by the controllable brake device (BK101) controlling the epicyclic gear set (EG101) can be widely applied in a power train driven by single rotary kinetic power source, and the structural type can be an in-series coaxial line structure, or multiple in-parallel axial lines for satisfying the requirements of the applied space, which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK101): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the sleeve type rotation shaft (AS101) or the rocker arm (A101), and the other action side is fixed in the housing (H100);
One end of the rotation shaft (S101) is combined with the input wheel (W101) of the epicyclic gear set (EG101), and the other end of the rotation shaft (S101) is combined with an output/input end rotation shaft (S1011) of the first rotary kinetic power source (P1), and the rotation shaft (S102) combined with the output wheel (W102) of the epicyclic gear set (EG101) is served as an output/input end, the shell of the epicyclic gear set (EG101) is fixed in the housing (H100), the epicyclic wheel (W103) of the epicyclic gear set (EG101) is provided for combining the rocker arm (A101) and combining the sleeve type rotation shaft (AS101), the sleeve type rotation shaft (AS101) rotates on the rotation shaft (S101), the sleeve type rotation shaft (AS101) or the rocker arm (A101) is combined to an action side of the controllable brake device (BK101), and the other action side of the controllable brake device (BK101) is fixed in the housing (H100); through controlling the controllable brake device (BK101) to perform brake locking or releasing, the function of connecting for transmission or releasing between the rotation shaft (S101) and the rotation shaft (S102) is enabled to be controlled.

2. A power train having controllable epicyclic type clutch device as claimed in claim 1, wherein a first transmission device (T1) is further installed between the first rotary kinetic power source (P1) and the rotation shaft (S101) driven by the input wheel (W101) of the epicyclic gear set (EG101), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK101): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the sleeve type rotation shaft (AS101) or the rocker arm (A101), and the other action side is fixed in the housing (H100);
First transmission device (T1): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
The other end of the rotation shaft (S101) combined with the input wheel (W101) of the epicyclic gear set (EG101) is combined with the output/input end rotation shaft (S1012) of the first transmission device (T1), the output/input end rotation shaft (S1013) at the other end of the first transmission device (T1) is combined with an output/input end rotation shaft (S1011) of the first rotary kinetic power source (P1), and the rotation shaft (S102) combined with the output wheel (W102) of the epicyclic gear set (EG101) is served as an output/input end, the shell of the epicyclic gear set (EG101) is fixed in the housing (H100), the epicyclic wheel (W103) of the epicyclic gear set (EG101) is provided for combining the rocker arm (A101) and combining the sleeve type rotation shaft (AS101), the sleeve type rotation shaft (AS101) rotates on the rotation shaft (S101), the sleeve type rotation shaft (AS101) or the rocker arm (A101) is combined to an action side of the controllable brake device (BK101), and the other action side of the controllable brake device (BK101) is fixed in the housing (H100); through controlling the controllable brake device (BK101) to perform brake locking or releasing, the function of connecting for transmission or releasing between the rotation shaft (S101) and the rotation shaft (S102) is enabled to be controlled.

3. A power train having controllable epicyclic type clutch device as claimed in claim 1, wherein he output wheel (W102) of the epicyclic gear set (EG101) and the output/input end of the rotation shaft (S102) s further installed with a second transmission device (T2) and an output/input end rotation shaft (S1021), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK101): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the sleeve type rotation shaft (AS101) or the rocker arm (A101), and the other action side is fixed in the housing (H100);
Second transmission device (T2): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
The rotation shaft (S101) combined with the input wheel (W101) of the epicyclic gear set (EG101) is combined with the output/input end rotation shaft (S1011) of the first rotary kinetic power source (P1), and the rotation shaft (S102) combined with the output wheel (W102) of the epicyclic gear set (EG101) is combined with the output/input end rotation shaft (S1022) of the second transmission device (T2), the output/input end rotation shaft (S1023) at the other end of the second transmission device (T2) is combined with the rotation shaft (S1021) for serving as an output/input end, the shell of the epicyclic gear set (EG101) is fixed in the housing (H100), the epicyclic wheel (W103) of the epicyclic gear set (EG101) is provided for combining the rocker arm (A101) and combining the sleeve type rotation shaft (AS101), the sleeve type rotation shaft (AS101) rotates on the rotation shaft (S101), the sleeve type rotation shaft (AS101) or the rocker arm (A101) is combined to an action side of the controllable brake device (BK101), and the other action side of the controllable brake device (BK101) is fixed in the housing (H100); through controlling the controllable brake device (BK101) to perform brake locking or releasing, the function of connecting for transmission or releasing between the rotation shaft (S101) and the rotation shaft (S102) is enabled to be controlled.

4. A power train having controllable epicyclic type clutch device as claimed in claim 1, wherein the first transmission device (T1) is further installed between the first rotary kinetic power source (P1) and the rotations shaft (S101) driven by the input wheel (W101) of the epicyclic gear set (EG101), and the output wheel (W102) of the epicyclic gear set (EG101) and the output/input end of the rotation shaft (S102) is installed with the second transmission device (T2) and the output/input end rotation shaft (S1021), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK101): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the sleeve type rotation shaft (AS101) or the rocker arm (A101), and the other action side is fixed in the housing (H100);
First transmission device (T1), Second transmission device (T2): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
The other end of the rotation shaft (S101) combined with the input wheel (W101) of the epicyclic gear set (EG101) is combined with the output/input end rotation shaft (S1012) of the first transmission device (T1), and the output/input end rotation shaft (S1013) at the other end of the first transmission device (T1) is combined with the output/input end rotation shaft (S1011) of the first rotary kinetic power source (P1), the rotation shaft (S102) combined with the output wheel (W102) of the epicyclic gear set (EG101) is combined with the output/input end rotation shaft (S1022) of the second transmission device (T2), the output/input end rotation shaft (S1023) at the other end of the second transmission device (T2) is combined with the rotation shaft (S1021) for serving as an output/input end, the shell of the epicyclic gear set (EG101) is fixed in the housing (H100), the epicyclic wheel (W103) of the epicyclic gear set (EG101) is provided for combining the rocker arm (A101) and combining the sleeve type rotation shaft (AS101), the sleeve type rotation shaft (AS101) rotates on the rotation shaft (S101), the sleeve type rotation shaft (AS101) or the rocker arm (A101) is combined to an action side of the controllable brake device (BK101), and the other action side of the controllable brake device (BK101) is fixed in the housing (H100); through controlling the controllable brake device (BK101) to perform brake locking or releasing, the function of connecting for transmission or releasing between the rotation shaft (S101) and the rotation shaft (S102) is enabled to be controlled.

5. A power train having controllable epicyclic type clutch device as claimed in claim 1, wherein the rotation shaft (S102) combined with the first rotary kinetic power source (P1) and the transmission unit (T200) and the epicyclic gear set (EG101) and the output wheel (W102) of the epicyclic gear set (EG101) are combined at an action side of a controllable brake device (BK102), and the other action side of the controllable brake device (BK102) is fixed in the housing (H100), and the rocker arm (A101) or the sleeve type rotation shaft (AS101) driven by the epicyclic wheel (W103) of the epicyclic gear set (EG101) is combined with the an input end rotation shaft (S1031) of the transmission unit (T200), and the output end of the transmission unit (T200) is installed with a rotation shaft (S110), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Transmission unit (T200): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
One end of the rotation shaft (S101) is combined with an output/input end rotation shaft (S1011) of the first rotary kinetic power source (P1), and the other end of the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to an action side of the controllable brake device (BK102), the other action side of the controllable brake device (BK102) is fixed in the housing (H100), the epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101), the sleeve type rotation shaft (AS101) drives the output/input end rotation shaft (S1031) of the transmission unit (T200), and the other output/input end rotation shaft (S1032) of the transmission unit (T200) drives the output/input end rotation shaft (S110).

6. A power train having controllable epicyclic type clutch device as claimed in claim 5, wherein the first transmission device (T1) is further installed between the rotation shaft (S101) combined with the input wheel (W101) of the epicyclic gear set (EG101) and the first rotary kinetic power source (P1), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
First transmission device (T1): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
Transmission unit (T200): which is constituted by the automatic, manumatic, semi-automatic, or manual gear shifting device with fixed or variable speed ratios which is further structured by a transmission gear set composed of gears, friction wheels, pulleys and pulley belts, chains and chain wheels, or a planetary type transmission gear set, or an epicyclic type transmission gear set, the CVT, or the hydraulic transmission device;
The output/input end rotation shaft (S1011) of the first rotary kinetic power source (P1) is combined with the output/input end rotation shaft (S1013) of the first transmission device (T1), the output/input end rotation shaft (S1012) of the first transmission device (T1) is combined with the rotation shaft (S101), the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to an action side of the controllable brake device (BK102), the other action side of the controllable brake device (BK102) is fixed in the housing (H100), the epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101), and the sleeve type rotation shaft (AS101) drives the output/input end rotation shaft (S1031) of the transmission unit (T200), and the other output/input end rotation shaft (S1032) of the transmission unit (T200) drives the output/input end rotation shaft (S110).

7. A power train having controllable epicyclic type clutch device as claimed in claim 5, wherein a planetary gear set (T300) is further installed between the input end rotation shaft (S1031) of the transmission unit (T200) and the rocker arm (A101) or the sleeve type rotation shaft (AS101) driven by the epicyclic wheel (W103) of the epicyclic gear set (EG101), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
Transmission unit (T200): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Planetary gear set (T300): which is constituted by friction wheels or gears, including a sun wheel (W111), a planetary wheel (W112), an outer annular wheel (W113) and a shell to be fixed in the housing (H100), wherein the outer annular wheel (W113) is fixed on the shell then fixed on the housing (H100) or directly fixed on the shell, the planetary wheel (W112) is combined with the rocker arm (A111) and combined with the sleeve type rotation shaft (AS111), the sleeve type rotation shaft (AS111) rotates on the rotation shaft (S101) and drives the output/input end rotation shaft (S1031) of the transmission unit (T200), and the sun wheel (W111) is combined with the sleeve type rotation shaft (AS101) of the epicyclic gear set (EG101);
One end of the rotation shaft (S101) is combined with the output/input end rotation shaft (S1011) of the first rotary kinetic power source (P1), the other end of the rotation shaft (S101) is combined with the input wheel (W101) of the epicyclic gear set (EG101), the shell of the epicyclic gear set (EG101) is fixed in the housing (H100), the output/input end rotation shaft (S102) combined with the output wheel (W102) of the epicyclic gear set (EG101) is combined to an action side of the controllable brake device (BK102), and the other action side of the controllable brake device (BK102) is fixed in the housing (H100);
The epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101) and drives the sun wheel (W111) of the planetary gear set (T300), the outer annular wheel (W113) of the planetary gear set (T300) is fixed on the housing (H100) through the shell of the planetary gear set (T300) or the outer annular wheel (W113) is directly fixed in the housing (H100), the planetary wheel (W112) of the planetary gear set (T300) is combined with the rocker arm (A111) and combined with the sleeve type rotation shaft (AS111) for driving the output/input end rotation shaft (S1031) of the transmission unit (T200), and the other output/input end rotation shaft (S1032) of the transmission unit (T200) drives the rotation shaft (S110).

8. A power train having controllable epicyclic type clutch device as claimed in claim 5, wherein the first transmission device (T1) is installed between the rotation shaft (S101) combined with the input wheel (W101) of the epicyclic gear set (EG101) and the first rotary kinetic power source (P1), and the planetary gear set (T300) is installed between the input end rotation shaft (S1031) of the transmission unit (T200) and the rocker arm (A101) or the sleeve type rotation shaft (AS101) driven by the epicyclic wheel (W103) of the epicyclic gear set (EG101), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
First transmission device (T1): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Transmission unit (T200): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Planetary gear set (T300): which is constituted by friction wheels or gears, including a sun wheel (W111), a planetary wheel (W112), an outer annular wheel (W113) and a shell to be fixed in the housing (H100), wherein the outer annular wheel (W113) is fixed on the shell then fixed on the housing (H100) or directly fixed on the shell, the planetary wheel (W112) is combined with the rocker arm (A111) and combined with the sleeve type rotation shaft (AS111), the sleeve type rotation shaft (AS111) rotates on the rotation shaft (S101) and drives the output/input end rotation shaft (S1031) of the transmission unit (T200), and the sun wheel (W111) is combined with the sleeve type rotation shaft (AS101) of the epicyclic gear set (EG101);
The output/input end rotation shaft (S1011) of the first rotary kinetic power source (P1) is combined with the output/input end rotation shaft (S1013) of the first transmission device (T1), the output/input end rotation shaft (S1012) of the first transmission device (T1) is combined with the rotation shaft (S101), the rotation shaft (S101) is combined with the input wheel (W101) of the epicyclic gear set (EG101), the shell of the epicyclic gear set (EG101) is fixed in the housing (H100), the output/input end rotation shaft (S102) combined with the output wheel (W102) of the epicyclic gear set (EG101) is combined to an action side of the controllable brake device (BK102), and the other action side of the controllable brake device (BK102) is fixed in the housing (H100);
The epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101) and drives the sun wheel (W111) of the planetary gear set (T300), the outer annular wheel (W113) of the planetary gear set (T300) is fixed on the housing (H100) through the shell of the planetary gear set (T300) or the outer annular wheel (W113) is directly fixed in the housing (H100), the planetary wheel (W112) of the planetary gear set (T300) is combined with the rocker arm (A111) and combined with the sleeve type rotation shaft (AS111) for driving the output/input end rotation shaft (S1031) of the transmission unit (T200), and the other output/input end rotation shaft (S1032) of the transmission unit (T200) drives the rotation shaft (S110).

9. A power train having controllable epicyclic type clutch device as claimed in claim 5, wherein the transmission unit (T200) is replaced by a differential output epicyclic gear set (T400), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
Differential output epicyclic gear set (T400): an epicyclic gear set structured including by an output/input wheel (W401), an output/input wheel (W402) and an epicyclic wheel (W403), wherein the output/input wheel (W401) is combined with a differential output/input end rotation shaft (S401), the output/input wheel (W402) is combined with a differential output/input end rotation shaft (S402), the epicyclic wheel (W403) rotates on a rocker arm (A401), the rocker arm (A401) is combined with an annular input wheel (W400) for being combined with a sleeve type rotation shaft (AS401), and the sleeve type rotation shaft (AS401) rotates on one or both of the differential output/input end rotation shaft (S401) or the differential output/input end rotation shaft (S402), the annular input wheel (W400) is driven by a transmission wheel (W300), and the transmission wheel (W300) is driven by the external rotary kinetic power, i.e. driven by the sleeve type rotation shaft (AS101);
The mentioned output/input wheel (W401), the output/input wheel (W402) and the epicyclic wheel (W403) are composed of bevel gears or bevel friction wheels;
The transmission function structured by the transmission wheel (W300) and the annular input wheel (W400) includes being constituted by the automatic, manumatic, semi-automatic, or manual gear shifting device with fixed or variable speed ratios which is structured by the transmission gear set composed of gears, friction wheels, pulleys and pulley belts, chains and chain wheels, or the planetary type transmission gear set, or the epicyclic type transmission gear set, or CVT, or the hydraulic transmission device, and a shell and the bearings;
One end of the rotation shaft (S101) is combined with the output/input end rotation shaft (S1011) of the first rotary kinetic power source (P1), the other end of the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to an action side of the controllable brake device (BK102), the other action side of the controllable brake device (BK102) is fixed in the housing (H100), the epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101), and the sleeve type rotation shaft (AS101) is used to drive the output/input end rotation shaft (S1041) of the differential output epicyclic gear set (T400), and the transmission wheel (W300) drives the annular input wheel (W400) and then through the epicyclic wheel (W403) drives the output/input wheel (W401) and the output/input wheel (W402), the differential output/input end rotation shaft (S401) is connected to the output/input wheel (W401) for being driven by the output/input wheel (W401), the differential output/input end rotation shaft (S402) is connected to the output/input wheel (W402) for being driven by the output/input wheel (W402), and the differential operation is enabled to be performed between the differential output/input end rotation shaft (S401) and the differential output/input end rotation shaft (S402) through the epicyclic wheel (W403).

10. A power train having controllable epicyclic type clutch device as claimed in claim 6, wherein the transmission unit (T200) is replaced by the differential output epicyclic gear set (T400), which mainly consists of
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
First transmission device (T1): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Differential output epicyclic gear set (T400): an epicyclic gear set structured including by having an output/input wheel (W401), an output/input wheel (W402) and an epicyclic wheel (W403), wherein the output/input wheel (W401) is combined with a differential output/input end rotation shaft (S401), the output/input wheel (W402) is combined with a differential output/input end rotation shaft (S402), the epicyclic wheel (W403) rotates on a rocker arm (A401), the rocker arm (A401) is combined with an annular input wheel (W400) for being combined with a sleeve type rotation shaft (AS401), and the sleeve type rotation shaft (AS401) rotates on one or both of the differential output/input end rotation shaft (S401) or the differential output/input end rotation shaft (S402), the annular input wheel (W400) is driven by a transmission wheel (W300), and the transmission wheel (W300) is driven by the external rotary kinetic power, i.e. driven by the sleeve type rotation shaft (AS101);
The mentioned output/input wheel (W401), the output/input wheel (W402) and the epicyclic wheel (W403) are composed of bevel gears or bevel friction wheels;
The transmission function structured by the transmission wheel (W300) and the annular input wheel (W400) includes being constituted by the automatic, manumatic, semi-automatic, or manual gear shifting device with fixed or variable speed ratios which is structured by the transmission gear set composed of gears, friction wheels, pulleys and pulley belts, chains and chain wheels, or the planetary type transmission gear set, or the epicyclic type transmission gear set, or CVT, or the hydraulic transmission device, and a shell and the bearings;
The output/input end rotation shaft (S1011) of the first rotary kinetic power source (P1) is combined with the output/input end rotation shaft (S1013) of the first transmission device (T1), the output/input end rotation shaft (S1012) of the first transmission device (T1) is combined with the rotation shaft (S101), the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to an action side of the controllable brake device (BK102), the other action side of the controllable brake device (BK102) is fixed in the housing (H100), the epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101), and the sleeve type rotation shaft (AS101) is used to drive the output/input end rotation shaft (S1041) of the differential output epicyclic gear set (T400), and the transmission wheel (W300) drives the annular input wheel (W400) and then through the epicyclic wheel (W403) drives the output/input wheel (W401) and the output/input wheel (W402), the differential output/input end rotation shaft (S401) is connected to the output/input wheel (W401) for being driven by the output/input wheel (W401), the differential output/input end rotation shaft (S402) is connected to the output/input wheel (W402) for being driven by the output/input wheel (W402), and the differential operation is enabled to be performed between the differential output/input end rotation shaft (S401) and the differential output/input end rotation shaft (S402) through the epicyclic wheel (W403).

11. A power train having controllable epicyclic type clutch device as claimed in claim 7, wherein the transmission unit (T200) is replaced by the differential output epicyclic gear set (T400), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected the rotation shaft (S102), and the other action side is fixed in the housing (H100);
Differential output epicyclic gear set (T400): an epicyclic gear set structured including by having an output/input wheel (W401), an output/input wheel (W402) and an epicyclic wheel (W403), wherein the output/input wheel (W401) is combined with a differential output/input end rotation shaft (S401), the output/input wheel (W402) is combined with a differential output/input end rotation shaft (S402), the epicyclic wheel (W403) rotates on a rocker arm (A401), the rocker arm (A401) is combined with an annular input wheel (W400) for being combined with a sleeve type rotation shaft (AS401), and the sleeve type rotation shaft (AS401) rotates on one or both of the differential output/input end rotation shaft (S401) or the differential output/input end rotation shaft (S402), the annular input wheel (W400) is driven by a transmission wheel (W300), and the transmission wheel (W300) is driven by the external rotary kinetic power, i.e. driven by the sleeve type rotation shaft (AS111);
The mentioned output/input wheel (W401), the output/input wheel (W402) and the epicyclic wheel (W403) are composed of bevel gears or bevel friction wheels;
The transmission function structured by the transmission wheel (W300) and the annular input wheel (W400) includes being constituted by the automatic, manumatic, semi-automatic, or manual gear shifting device with fixed or variable speed ratios which is structured by the transmission gear set composed of gears, friction wheels, pulleys and pulley belts, chains and chain wheels, or the planetary type transmission gear set, or the epicyclic type transmission gear set, or CVT, or the hydraulic transmission device, and a shell and the bearings;
Planetary gear set (T300): which is constituted by friction wheels or gears, including a sun wheel (W111), a planetary wheel (W112), an outer annular wheel (W113) and a shell to be fixed in the housing (H100), wherein the outer annular wheel (W113) is fixed on the shell then fixed on the housing (H100) or directly fixed on the shell, the planetary wheel (W112) is combined with the rocker arm (A111) and combined with the sleeve type rotation shaft (AS111), the sleeve type rotation shaft (AS111) rotates on the rotation shaft (S101) and drives the output/input end rotation shaft (S1041) of the differential output epicyclic gear set (T400), and the sun wheel (W111) is combined with the sleeve type rotation shaft (AS101) of the epicyclic gear set (EG101);
One end of the rotation shaft (S101) is combined with the rotation shaft (S101) of the first rotary kinetic power source (P1), the other end of the rotation shaft (S101) is combined with the input wheel (W101) of the epicyclic gear set (EG101), the shell of the epicyclic gear set (EG101) is fixed in the housing (H100), the output/input end rotation shaft (S102) combined with the output wheel (W102) of the epicyclic gear set (EG101) is combined to an action side of the controllable brake device (BK102), and the other action side of the controllable brake device (BK102) is fixed in the housing (H100);
The epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101) and drives the sun wheel (W111) of the planetary gear set (T300), the outer annular wheel (W113) of the planetary gear set (T300) is fixed in the housing (H100) through the shell of the planetary gear set (T300) or the outer annular wheel (W113) is directly fixed in the housing (H100), the planetary wheel (W112) of the planetary gear set (T300) is combined with the rocker arm (A111) and combined with the sleeve type rotation shaft (AS111) for driving the output/input end rotation shaft (S1041) of the differential output epicyclic gear set (T400), and the transmission wheel (W300) drives the annular input wheel (W400) and then through the epicyclic wheel (W403) drives the output/input wheel (W401) and the output/input wheel (W402), the differential output/input end rotation shaft (S401) is connected to the output/input wheel (W401) for being driven by the output/input wheel (W401), the differential output/input end rotation shaft (S402) is connected to the output/input wheel (W402) for being driven by the output/input wheel (W402), and the differential operation is enabled to be performed between the differential output/input end rotation shaft (S401) and the differential output/input end rotation shaft (S402) through the epicyclic wheel (W403).

12. A power train having controllable epicyclic type clutch device as claimed in claim 8, wherein the transmission unit (T200) is replaced by the differential output epicyclic gear set (T400), which mainly consists of:
First rotary kinetic power source (P1): which is constituted by one or more than of one of rotary kinetic power sources capable of generating the output of rotary kinetic power, including an internal combustion engine, external combustion engine, Sterling engine, turbine engine, electric-driven engine, wind-driven blade power set, flow-driven power set, or manual power;
Epicyclic gear set (EG101): which is constituted by an input wheel (W101) and an output wheel (W102) and at least an epicyclic wheel (W103), and including through bevel gears engaging with each other, or through bevel friction wheels mutually performing friction transmissions to form an epicyclic gear set function, and structured by the rotation shaft (S101), the rotation shaft (S102), the rocker arm (A101), the sleeve type rotation shaft (AS101) and a bearing, and installed with a shell for being combined with the housing (H100);
Controllable brake device (BK102): which is constituted by a brake device controlled by a manual force or mechanical force or hydraulic force or pneumatic force or electromagnetic force, and having two controllable action sides for the operations of a brake locking state for engagement or a releasing state for separation, wherein one of the action sides is connected to the rotation shaft (S102), and the other action side is fixed in the housing (H100);
First transmission device (T1): which is constituted by the automatic, manumatic, semi-automatic, or manual gear shifting device with fixed or variable speed ratios which is structured by a transmission gear set composed of gears, friction wheels, pulleys and pulley belts, chains and chain wheels, or a planetary type transmission gear set, or an epicyclic type transmission gear set, or the CVT, or the hydraulic transmission device;
Planetary gear set (T300): which is constituted by friction wheels or gears, including a sun wheel (W111), a planetary wheel (W112), an outer annular wheel (W113) and a shell to be fixed in the housing (H100), wherein the outer annular wheel (W113) is fixed on the shell then fixed on the housing (H100) or directly fixed on the shell, the planetary wheel (W112) is combined with the rocker arm (A111) and combined with the sleeve type rotation shaft (AS111), the sleeve type rotation shaft (AS111) rotates on the rotation shaft (S101) and drives the output/input end rotation shaft (S1041) of the differential output epicyclic gear set (T400), and the sun wheel (W111) is combined with the sleeve type rotation shaft (AS101) of the epicyclic gear set (EG101);
Differential output epicyclic gear set (T400): an epicyclic gear set structured including by having an output/input wheel (W401), an output/input wheel (W402) and an epicyclic wheel (W403), wherein the output/input wheel (W401) is combined with a differential output/input end rotation shaft (S401), the output/input wheel (W402) is combined with a differential output/input end rotation shaft (S402), the epicyclic wheel (W403) rotates on a rocker arm (A401), the rocker arm (A401) is combined with an annular input wheel (W400) for being combined with a sleeve type rotation shaft (AS401), and the sleeve type rotation shaft (AS401) rotates on one or both of the differential output/input end rotation shaft (S401) or the differential output/input end rotation shaft (S402), the annular input wheel (W400) is driven by a transmission wheel (W300), and the transmission wheel (W300) is driven by the external rotary kinetic power, i.e. driven by the sleeve type rotation shaft (AS111);
The mentioned output/input wheel (W401), the output/input wheel (W402) and the epicyclic wheel (W403) are composed of bevel gears or bevel friction wheels;
The transmission function structured by the transmission wheel (W300) and the annular input wheel (W400) includes being constituted by the automatic, manumatic, semi-automatic, or manual gear shifting device with fixed or variable speed ratios which is structured by the transmission gear set composed of gears, friction wheels, pulleys and pulley belts, chains and chain wheels, or the planetary type transmission gear set, or the epicyclic type transmission gear set, or CVT, or the hydraulic transmission device, and a shell and the bearings;
The output/input end rotation shaft (S1011) of the first rotary kinetic power source (P1) is combined with the output/input end rotation shaft (S1013) of the first transmission device (T1), the output/input end rotation shaft (S1012) of the first transmission device (T1) is combined with the rotation shaft (S101), the rotation shaft (S101) is combined with the input wheel (W101) of the epicyclic gear set (EG101), the shell of the epicyclic gear set (EG101) is fixed in the housing (H100), and the output/input end rotation shaft (S102) combined with the output wheel (W102) of the epicyclic gear set (EG101) is combined to an action side of the controllable brake device (BK102), the other action side of the controllable brake device (BK102) is fixed in the housing (H100);
The epicyclic wheel (W103) of the epicyclic gear set (EG101) is combined with the rocker arm (A101) and combined with the sleeve type rotation shaft (AS101), the sleeve type rotation shaft (AS101) rotates on the rotation shaft (S101) and drives the sun wheel (W111) of the planetary gear set (T300), the outer annular wheel (W113) of the planetary gear set (T300) is fixed in the housing (H100) through the shell of the planetary gear set (T300) or the outer annular wheel (W113) is directly fixed in the housing (H100), the planetary wheel (W112) of the planetary gear set (T300) is combined with the rocker arm (A111) and combined with the sleeve type rotation shaft (AS111) for driving the output/input end rotation shaft (S1041) of the differential output epicyclic gear set (T400), and the transmission wheel (W300) drives the annular input wheel (W400) and then through the epicyclic wheel (W403) drives the output/input wheel (W401) and the output/input wheel (W402), the differential output/input end rotation shaft (S401) is connected to the output/input wheel (W401) for being driven by the output/input wheel (W401), the differential output/input end rotation shaft (S402) is connected to the output/input wheel (W402) for being driven by the output/input wheel (W402), and the differential operation is enabled to be performed between the differential output/input end rotation shaft (S401) and the differential output/input end rotation shaft (S402) through the epicyclic wheel (W403).

13. A power train having controllable epicyclic type clutch device as claimed in claim 9, wherein in the differential output epicyclic gear set (T400), a limited slip differential device (LSD401) can be further installed between shaft ends of the differential output/input end rotation shaft (S401) and the differential output/input end rotation shaft (S402) inside the output/input wheel (W401), the output/input wheel (W402) and the epicyclic wheel (W403).

14. A power train having controllable epicyclic type clutch device as claimed in claim 10, wherein in the differential output epicyclic gear set (T400), a limited slip differential device (LSD401) can be further installed between shaft ends of the differential output/input end rotation shaft (S401) and the differential output/input end rotation shaft (S402) inside the output/input wheel (W401), the output/input wheel (W402) and the epicyclic wheel (W403).

15. A power train having controllable epicyclic type clutch device as claimed in claim 11, wherein in the differential output epicyclic gear set (T400), a limited slip differential device (LSD401) can be further installed between shaft ends of the differential output/input end rotation shaft (S401) and the differential output/input end rotation shaft (S402) inside the output/input wheel (W401), the output/input wheel (W402) and the epicyclic wheel (W403).

16. A power train having controllable epicyclic type clutch device as claimed in claim 12, wherein in the differential output epicyclic gear set (T400), a limited slip differential device (LSD401) can be further installed between shaft ends of the differential output/input end rotation shaft (S401) and the differential output/input end rotation shaft (S402) inside the output/input wheel (W401), the output/input wheel (W402) and the epicyclic wheel (W403).
